(19) United States
(12) Patent Application Publication
(10) Pub. No.: US 2005/0146839 A1
(43) Pub. Date: Jul. 7, 2005

(54) Forming thin layer structures by ablation

(75) Inventor: Masud Beroz, Livermore, CA (US)

Correspondence Address: LERNER DAVID, LITENBERG, KRUMHOLZ & MENTLIK, 600 SOUTH AVENUE WEST, WESTFIELD, NJ, 07090, US

(73) Assignee: Tessera, Inc., San Jose, CA (US)

(21) Appl. No.: 11/019,823

(22) Filed: Dec. 22, 2004

Related U.S. Application Data
(60) Provisional application No. 60/533,355, filed on Dec. 30, 2003.

(51) Int. Cl. H01G 4/06

(52) U.S. Cl. 361/312

(57) ABSTRACT

An element having a predetermined thickness, such as a thin dielectric layer for a capacitor, is formed by directing light onto a region of a starting material towards a support structure so that said light ablates the starting material in said region and starting material remaining in said region forms the desired layer. Most preferably, the light-directing step is continued at least until the light substantially ceases to ablate the starting material in the region. The process is self-limiting, and most preferably provides repeatable layer thicknesses. The process can be used to form thin capacitor dielectrics integral with structural layers of circuit panels and microelectronic package elements

### CROSS-REFERENCE TO RELATED APPLICATIONS

The present application claims the benefit of the filing date of U.S. Provisional Patent Application No. 60/533,355, filed Dec. 30, 2003, the disclosure of which is hereby incorporated herein by reference.

### BACKGROUND OF THE INVENTION

The present invention relates to fabrication of electronic elements incorporating thin layers, as, for example, capacitors, resistors and fusible elements, and to fabrication of components and structures incorporating such elements, and to the resulting products.

A capacitor is an electrical element which includes a pair of electrically-conductive elements, commonly referred to as “plates” and a capacitor dielectric layer disposed between the plates. A capacitor stores electrical charge. The capacitance or amount of charge per unit of electrical potential difference between the plates is directly related to the area of the plates and inversely related to the thickness of the capacitor dielectric layer.

Capacitors are widely used in microelectronic assemblies which also include connection components having one or more dielectric layers and electrically-conductive components such as terminals and traces carried on the dielectric layer or layers. For example, many electronic circuits include connection components referred to as circuit boards which incorporate one or more dielectric layers and strip-like electrically-conductive traces extending along these layers. Also, packaged semiconductor chips include connection components which physically protect the chip itself and which facilitate handling or connection of the chip to a larger circuit. The package structure typically includes a connection component having one or more dielectric layers and conductive features such as terminals which are electrically connected to the chip itself The packaged chip can be connected to a larger circuit by connecting the terminals to a larger circuit, for example, by bonding the terminals to conductive features of a circuit board.

It has been proposed to provide one or more capacitors in such assemblies by forming plates on opposite sides of a dielectric layer which forms part of a connection component required for other purposes, and to form the plates of the capacitor along with the other conductive features required in the connection component. In theory, this approach would provide the capacitors for essentially no cost, and would also avoid the handling and processing steps required to assemble separate capacitors with the other components. However, this approach has not been widely used in practice. To provide the requisite structural integrity, the dielectric layers commonly used as structural elements of connection components are far thicker than those desired in capacitor dielectric layers for use in microelectronic assemblies. A capacitor with a capacitor dielectric layer equal in thickness to the structural dielectric layer has relatively low capacitance per unit area. To provide the necessary capacitance, the plates of such a capacitor would have to be so large that they cannot fit in the space available on the component.

Similar problems occur in fabrication of resistors. A resistor may include a resistive or semiconducting material such as an electrically conductive polymer; a dispersion of highly conductive particles in a dielectric binder such as a polymer or a glass; a metal; or a semiconductor. The resistive material is electrically connected between two or more connection points. Because the electrical resistance between the connection points is inversely related to the thickness of the resistive material, it is often desirable to form the resistive material as a strip with a small, well-controlled thickness. Fusible elements are constructed so that when an electrical current of a particular magnitude passes through the element, the heat evolved in the element causes element to evaporate or change in some other way so that the connection is destroyed. Such fusible elements are used, for example, to provide temporary test connections or optional connections which can be disabled as desired. Fusible elements may include thin strips of materials similar to those used in resistors. Techniques such as sputtering, vapor deposition and the like can be used to form thin layers of certain materials. However, these techniques are not applicable to all resistive materials and can be costly. It would be desirable to provide techniques which allow formation of thin features from a wide range of materials. It would be desirable to provide techniques which allow formation of a thin layer, strip or other feature of a resistive material from a thicker starting layer which can be formed and handled by conventional techniques.

### SUMMARY OF THE INVENTION

One aspect of the present invention incorporates the realization that a phenomenon normally regarded as a nuisance in a hole-punching process can be used to form thin features. For example, such phenomenon can be used to form capacitor dielectric layers in thicknesses which provide practical capacitance values in capacitors of reasonable area. Holes have been formed in dielectric layers by directing light such as light from a laser onto a small region of the dielectric, so that the light heats the dielectric and ablates the dielectric material in such region. It is often desirable to form a hole through the dielectric layer in a region occupied on one side by a metallic feature. It is difficult to form a hole all the way through the dielectric layer to the metallic feature by directing laser light onto the opposite side of the dielectric layer. Although some ablation occurs, secondary processes such as plasma etching typically are required to form a hole which penetrates all the way through to the metallic feature.

One aspect of the present invention incorporates the realization that this difficulty results from the fact that at least under a given set of conditions such as a particular light wavelength and intensity, a given dielectric composition and a given structure on the side opposite the side illuminated by the light, the ablation process substantially stops when the dielectric in the ablated region reaches a given thickness. This phenomenon can be used to provide capacitor dielectrics of the thicknesses required to provide practical capacitance values.

The same phenomenon can be used to form dielectric structures for purposes other than capacitor dielectrics. Moreover, the same phenomenon can be applied to materials other than dielectric materials, to form thin features from starting structures of resistive or electrically conductive materials.

### BRIEF DESCRIPTION OF THE DRAWINGS

FIG. 1 is a diagrammatic top plan view of certain components used in a process according to one embodiment of the invention.

FIG. 2 is a fragmentary, diagrammatic sectional view taken along line 2-2 in FIG. 1, showing a component in conjunction with another element at one stage in the process.

FIG. 3 is a view similar to FIG. 2 but depicting the component at a later stage of the process.

FIG. 4 is a view similar to FIGS. 2 and 3 but depicting the component at a still later stage.

FIG. 5 is a diagrammatic top plan view of a component made by the process of FIGS. 2-4.

FIG. 6 is a diagrammatic perspective view of an assembly including the component of FIG. 5.

FIGS. 7A and 7B are views similar to FIGS. 2 and 3 depicting stages in a process according to a further embodiment of the invention.

FIG. 7C is a fragmentary, diagrammatic top plan view of a component made by a process according to FIGS. 7A and 7B.

FIG. 7D is a sectional view along lines 7D-7D in FIG. 7C.

### DETAILED DESCRIPTION

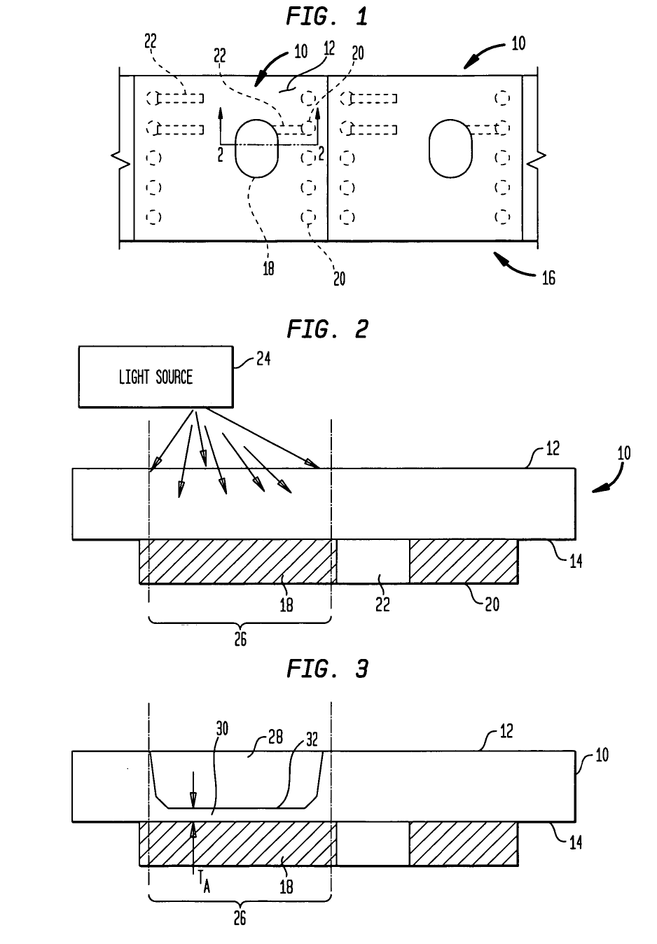

A process according to one embodiment of the present invention utilizes a starting structure incorporating a main dielectric layer 10 as, for example, a dielectric layer of the type commonly used to form a flexible printed circuit or a element for use in a semiconductor chip package. Merely by way of example, layer 10 may be a layer of a polymeric dielectric such as polyimide, BT-resin or the like, preferably 20 microns or more in thickness, more preferably about 20-150 microns thick. As seen in FIG. 1, main layer 10 may be provided as a part of a larger continuous sheet or tape incorporating layers for numerous connection components for packaging element. Layer 10 has a first side 12 and a second, opposite side 14. At this stage of the process, the main layer has metallic features on its second side, which features include a metallic support structure 18 which will later form a plate of a capacitor, and which may also include additional metallic features such as pads 20 and traces 22. One or more of these additional features may be formed integrally with support structure 18. The additional features may have any arrangement compatible with circuit requirements; only a few such features are illustrated in FIG. 1 for clarity of illustration. In practice, numerous features may be incorporated in such a structure. Also, support structure 18 is depicted as occupying a larger surface area than other metallic features, but no such relationship is required in practice; the support structure can be larger or smaller than other features. In the particular illustrative embodiment of FIG. 1, support structure 18 desirably is formed from a metallic material such as copper or a copper-based alloy and desirably is about 10 microns or more in thickness. As used herein, the term “thickness” refers to the dimension of a feature in the direction normal to second surface 14 of dielectric layer 10. The other metallic features 22 and 20 may be of the same or different thicknesses. The metallic features may be formed by conventional processes such as sputter-deposition and plating. Desirably, the support structure 18 defines a light-reflective interface at the second surface 14 of the dielectric layer.

Light from a source 24 is directed onto the dielectric material of layer 10 through the first surface 12 within a region 26 of the main layer and first surface overlying a portion or all of support structure 18. Light source 24 desirably is a laser or other conventional source of intense, preferably monochromatic light and may include elements such as focusing lenses and mirrors for directing light into a desired area. In a particularly preferred arrangement, light source 24 includes a CO₂ laser arranged to provide monochromatic light at about 10 μm wavelength. As used in this disclosure, the term “light” includes electromagnetic radiation in the infrared and ultraviolet regions of the spectrum, as well as radiation in the visible region of the spectrum. Light source 24 may be a source of the type commonly used in laser ablation of dielectrics. The wavelength of the light and the dielectric in layer 10 are selected so that the polymer is at least partially transparent to the applied light, but has some absorptivity at the wavelength of the applied light.

As the light is applied, it passes into the dielectric in layer 10 within region 26 and rapidly heats the polymer within such region, at least in that portion of the layer remote from support structure 10, i.e., remote from bottom surface 14. Such absorption causes rapid degradation of the polymer and evaporation of the resulting polymer constituents, so that the dielectric material in layer 10 is rapidly ablated within region 26. The ablation process removes material from layer 10, thus progressively forming a depression 28 open to the first surface 12 within the ablation region 26. Depression 28 deepens with continued application of the light from source 24. However, the ablation process slows and substantially ceases even where application of the light from source 24 is continued. This leaves a thin ablated dielectric layer 30 at the bottom of depression 28, overlying support structure 18. The thickness T_{A} of the remaining ablated layer 30 remains substantially constant, even with continued application of the light. Stated another way, ablation using the applied light ceases when the ablated layer reaches a predetermined thickness, so that the thickness T_{A} of the ablated layer does not substantially decreases even though the light application process continues. For a given dielectric, a given light source and given light application conditions, this thickness T_{A} of the remaining ablated layer has a predetermined value. That is, the process can be repeated numerous times under the same conditions, and T_{A} will be substantially the same on each repetition. Typically, T_{A} is substantially less than 20 microns and normally about 1 micron or less. The thickness of the remaining layer 30 is exaggerated relative to other features in FIG. 3 for clarity of illustration.

The exact reason why the process produces this repeatable, well-controlled thickness is not well known, and the present invention is not limited by any theory of operation. Regardless of the theory of operation, the ablated layer 30 tends to reach a substantially constant thickness T_{A}. Thus, the process tends to provide the same ablated layer thickness when repeated numerous times. This facilitates control of capacitance provided in the finished structure.

Although this phenomenon has been described as a series of successive conditions in time, it should be appreciated that these conditions follow one another in rapid sequence. Typically, only milliseconds elapse from the beginning of the ablation step (the condition shown in FIG. 2) until the ablated layer reaches a constant thickness T_{A} (FIG. 3). Also, although application of the light has been referred to as continuing, such continuing application does not require continuous-wave application. In some cases, the light may be applied as a series of rapidly-recurring pulses, and such pulsatile application may continue until the thickness of the ablated layer reaches a substantially constant value.

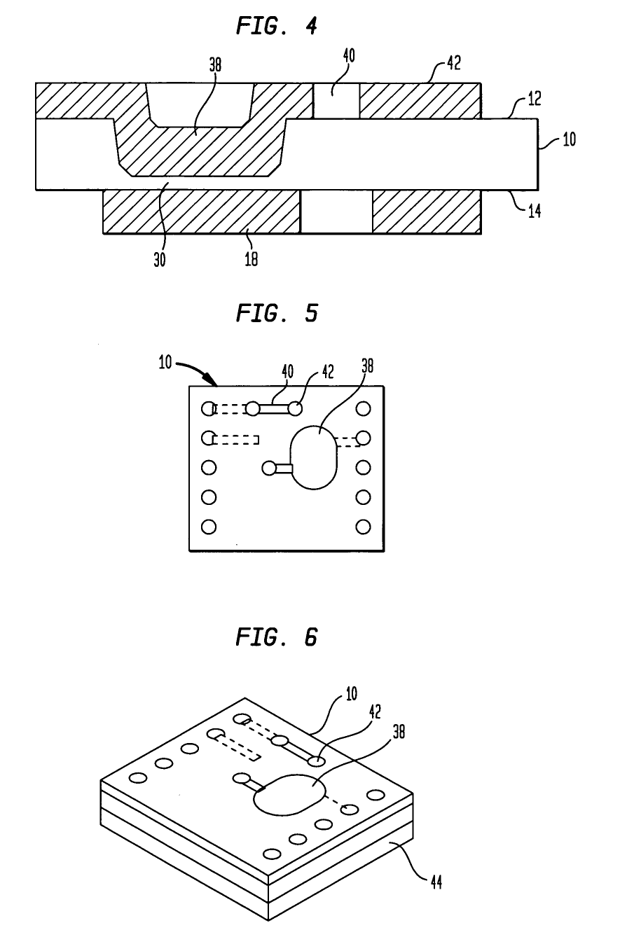

After completion of the ablation step, support structure 18 is left in place on second surface 14, and hence, forms a plate disposed on one side of ablated layer 30. A further electrically-conductive, preferably metallic structure 38 (FIG. 4) is applied on the opposite side of the ablated layer to form another plate. Additional conductive, and preferably metallic, features such as traces 40 and additional pads or terminals 42 may be applied on the first surface 12 of dielectric layer 10. Using conventional techniques, some or all of these additional features may be electrically connected to pads 20 on the first surface. Additional layers and features may be added to the structure as well. Plate 38 and additional features 40 and 42 may be formed, for example, by depositing a continuous metal layer, using conventional processes such as sputtering or plating, and then etching the continuous layer. Alternatively, these features may be formed by selective deposition processes such as selective sputtering or plating, using conventional masking techniques so as to deposit conductive material only in the areas where it is desired. These process steps can be performed while layer 10 forms part of the larger tape or sheet seen in FIG. 1.

As shown in FIG. 6, the component formed by the foregoing process steps can be used as a package element for a microelectronic device such as a semiconductor chip 44. The component may overlie a surface of the chip, and features such as pads 42 on the exposed surface of layer 10 may be electrically connected to circuits within the chip, so that the exposed features 42 can serve as terminals for mounting the chip to other components such as a larger circuit board. Plates 18 and 38, together with the intervening ablated dielectric layer 30, form a capacitor which is connected in circuit with chip 44 by other conductive elements such as traces 22 and 40, discussed above. Although only one capacitor is depicted in the drawings, more than one capacitor may be formed in exactly the same manner in a single connection component. These capacitors may be connected so that one terminal of each capacitor is connected to a particular signal or power terminal 42, whereas the other plate of each capacitor is connected to a ground terminal 42.

In a variant of the process discussed above, support structure 18 is in the form of a continuous metallic sheet covering the second surface 14 of the dielectric. After the ablation process, portions of this continuous sheet are removed, as by selective etching, so as to leave a portion of the support structure in place as one plate of the capacitor, whereas other portions form conductive features on the second surface.

In a further variant, the support structure which is originally present beneath the ablated region may be removed after the ablation step and replaced by another structure which acts as a plate of the capacitor. In this case, the support structure used during ablation need not be electrically conductive. The same light source used to make one or more ablated regions as discussed above can also be directed onto other regions of the original dielectric layer 10. If these layers do not incorporate support structures as discussed above, the ablation process will continue until the entire layer is removed in these other regions, thereby forming apertures extending entirely through the dielectric layer. Such apertures can be used as bond windows to provide access for bonding elements of the completed component to structures such as semiconductor chips. Small openings can be partially or completely filled with conductive metal or other conductive material so as to provide electrically-conductive via connections through the dielectric layer.

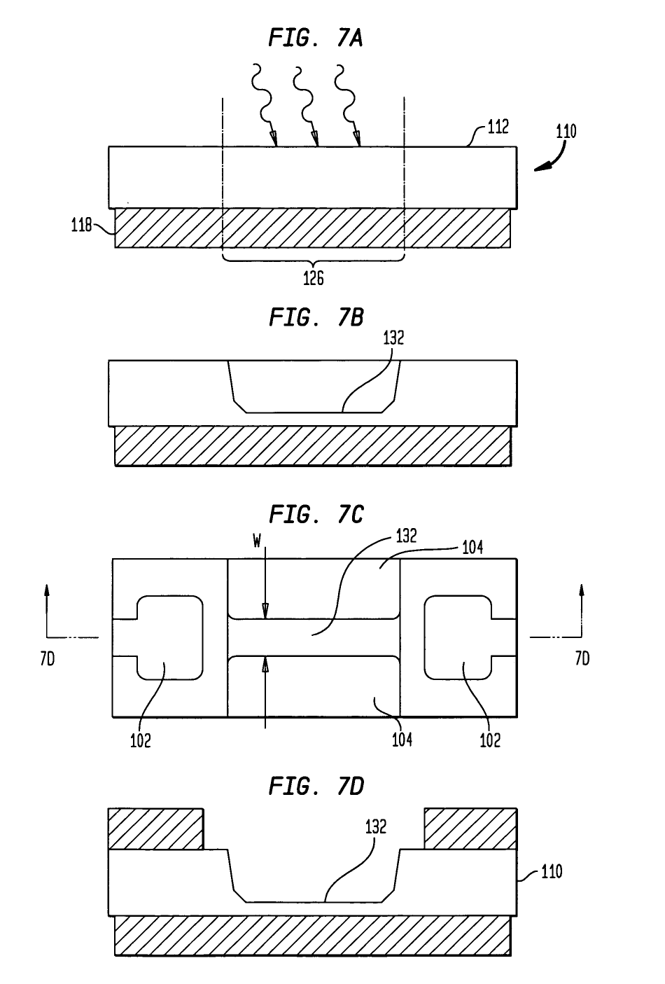

A process according to a further embodiment of the invention uses a starting layer 110 (FIG. 7A) of a starting material such as an electrically conductive polymer; a composition including electrically conductive particles in a binder such as a polymer or a glass; a metal; or a semiconductor, or any other electrically resistive material. The term “electrically resistive material” as used herein refers to a material having electrical conductivity and resistivity (the inverse of conductivity) such that the material can provide an element having a conductive connection having a practical resistance value. Merely by way of example, some useful electrically resistive materials have electrical conductivity between about 1 and about 10⁻⁷ IACS (International Annealed Copper Standard). A support layer 118 is provided in abutment with, or in close proximity to, the opposite, bottom surface of layer 110. In this embodiment, support layer 118 desirably is a dielectric. Light is directed onto the top surface 112 of a region 126 of the starting material, in much the same way as discussed above with reference to FIGS. 1 and 2. Here again, the light ablates the starting material. The ablation step most preferably is continued until the ablation substantially ceases, so that an ablated layer 132 (FIG. 7B) remains in region 126. Electrically conductive connection structures 102 (FIG. 7C) are provided so that these connection structures are conductively connected to one another by the ablated layer 132. Merely by way of example, the conductive connection structures may be metallic elements such as terminals suitable for connection to other electrical devices; traces extending along the surface of layer 110 or conductive features carried on the support layer 118. In a further variant, the support layer 118 may be a device such as a semiconductor chip or wafer, or a circuit panel incorporating dielectric and conductive elements, and the connection structures may be elements of such device or panel. The conductive elements may be placed before or after the ablation step. In the particular structure depicted, the connection structures 102 are connected to opposite edges of ablated layer 132 through adjacent, non-ablated portions of the original starting layer 110. However, this arrangement is not essential. For example, the connection structures may be disposed on the top and bottom sides of the ablated layer in much the same way as the plates of the capacitor discussed above, so that they are conductively connected to one another through the thickness of the layer. However, this arrangement typically provides a low resistance value. In yet another variant, support layer 118 may be removed at some time during the process. In this variant, support layer 118 does not form part of the completed element and hence may be a dielectric or conductive material selected to optimize the ablation process.

As best seen in FIG. 7D, the ablated layer 132 may be formed into a relatively narrow, elongated strip having limited width w by removing portions of the ablated layer to leave openings 104 after formation of the ablated layer. Alternatively, openings 104 may be formed in the starting layer prior to the ablation process as, for example, by punching holes in layer 110 or by initially forming the layer with such holes. Any other configuration can be formed by similar processes.

The same processes discussed above with reference to FIGS. 7A-7D can be used to form fusible elements. In this case, the starting material desirably is selected so that the ablated layer will decompose, melt or evaporate when a preselected electrical current is passed between the conductive connection structures.

Electrical elements for other purposes, and thin layers for purposes other than electrical purposes, can be formed using other starting materials. Essentially any material which can be ablated may be employed.

As these and other variations and combinations of the features discussed above can be utilized without departing from the present invention as defined by the claims, the foregoing description of the preferred embodiments should be taken by way of illustration rather than by way of limitation of the invention as defined by the claims.

1. A method of forming a capacitor comprising the steps of:
(a) directing light onto a region of a dielectric material towards a support structure so that said light ablates said dielectric in said region and dielectric material remaining in said region forms an ablated layer; and
(b) providing electrically-conductive plates on opposite sides of said ablated layer.

2. A method as claimed in claim 1 wherein said dielectric material is at least partially transparent to said light and said support structure is at least partially reflective to said light.

3. A method as claimed in claim 1 wherein said light-directing step is continued at least until the light substantially ceases to ablate the dielectric in said region.

4. A method as claimed in claim 3 wherein said light is substantially monochromatic.

5. A method as claimed in claim 1 wherein said step of directing light is performed by directing light from a laser onto said dielectric material.

6. A method as claimed in claim 5 wherein said laser is a CO₂ laser.

7. A method as claimed in claim 1 wherein said support structure is electrically-conductive and said step of providing electrically-conductive plates includes leaving said support structure in place on one side of said layer.

8. A method as claimed in claim 1 wherein said dielectric material, prior to said ablating step, is in the form of a main layer having opposite sides and said region of said dielectric includes less than all of said main layer.

9. A method as claimed in claim 8 further comprising the step of providing electrically-conductive features in addition to said plates on said sides of said main layer.

10. A method as claimed in claim 9 wherein said electrically-conductive features include one or more traces extending to said plates and formed integrally therewith.

11. A method as claimed in claim 9 wherein said support structure is electrically-conductive, said step of providing said plates includes leaving at least a part of said support structure in place on one side of said ablated layer, and said step of providing electrically-conductive features includes forming at least one electrically-conductive feature integrally with said support structure.

12. A method as claimed in claim 9 further comprising the step of assembling a semiconductor chip with said main layer and electrically connecting said semiconductor chip to at least some of said conductive features.

13. A method as claimed in claim 12 wherein said electrically-conductive features include terminals, said step of electrically connecting said chip to said features includes electrically connecting said chip to at least some of said terminals, said assembling and connecting step being performed so that at least some of said terminals remain exposed for connection to a larger circuit after said assembling and connecting steps.

14. A method as claimed in claim 1 wherein said support structure is a metallic structure having a thickness of at least about 10 μm.

15. A method as claimed in claim 14 wherein said support structure includes copper.

16. A structure made by a process as claimed in claim 1.

17. A plurality of structures as claimed in claim 16, the ablated layers in the capacitors of said structures being substantially uniform.

18. A microelectronic connection component comprising:
(a) a main dielectric layer at least about 20 μm thick;
(b) electrically-conductive features on said main dielectric layer,
(c) a capacitor including a capacitor dielectric integral with said main dielectric layer less than about 10 μm thick, and electrically-conductive plates disposed on opposite sides of said capacitor dielectric.

19. A component as claimed in claim 18 wherein said main dielectric layer has a substantially planar second surface and a first surface having a depression therein, said capacitor dielectric defining a bottom wall of said indentation.

20. A method of forming an element for a microelectronic structure comprising the steps of:
(a) directing light onto a region of a starting material towards a support structure so that said light ablates said starting material in said region and starting material remaining in said region forms an ablated layer; and
(b) providing two or more electrical connection points conductively connected to one another by said ablated layer.

21. A method as claimed in claim 20 wherein said starting material is at least partially transparent to said light and said support structure is at least partially reflective to said light.

22. A method as claimed in claim 20 wherein said light-directing step is continued at least until the light substantially ceases to ablate the starting material in said region.

23. A method as claimed in claim 20 wherein said starting material is an electrically resistive material.

24. A method as claimed in claim 20 wherein said starting material is selected from the group consisting of electrically conductive polymers, dispersions of electrically conductive particles in binders, metals and semiconductors.

25. A method of forming an element having a predetermined thickness comprising the step of directing light onto a region of a starting material towards a support structure so that said light ablates said starting material in said region and starting material remaining in said region forms an ablated layer; and continuing said light-directing step at least until the light substantially ceases to ablate the starting material in said region.

26. A method as claimed in claim 25 wherein said starting material is at least partially transparent to said light and said support structure is at least partially reflective to said light.

27. A method as claimed in claim 25 in which said starting material is a dielectric, the method further comprising the step of providing electrically-conductive plates on opposite sides of said ablated layer.

28. A method as claimed in claim 25 in which said starting material is an electrically resistive material, the method further comprising the step of providing electrically-conductive connection structures conductively connected to one another through said ablated layer.
